(19) United States
(12) Patent Application Publication
(10) Pub. No.: US 2026/0045617 A1
(43) Pub. Date: Feb. 12, 2026

(54) Modular Battery for an Electric Work Vehicle

(71) Applicant: Caterpillar Inc., Peoria, IL (US)

(72) Inventor: Thomas L. TWIGGER, Spalding, Lincolnshire (GB)

(73) Assignee: Caterpillar Inc., Peoria, IL (US)

(21) Appl. No.: 19/100,246

(22) PCT Filed: Jul. 25, 2023
(86) PCT No.: PCT/US2023/070923

§ 371 Date: Jan. 31, 2025

(30) Foreign Application Priority Data
Aug. 5, 2022 (GB) 2211431.8

(51) Int. Cl. H01M 50/258; H01M 10/42; H02J 7/34

(52) U.S. Cl. CPC H01M 50/258; H01M 10/425; H02J 7/342; H01M 2220/20; H01M 2220/30

(57) ABSTRACT

A modular battery for an electric work vehicle. The modular battery comprises a first battery pack configured to power the electric work vehicle. The modular battery comprises a second battery pack configured to power the electric work vehicle and to power an auxiliary electric power tool. The second battery pack is configured to be removable from the modular battery and wherein the second battery pack comprises a power converter.

### FIELD OF THE DISCLOSURE

The disclosure relates to the field of electric work vehicles.

### BACKGROUND

Work vehicles often comprise integrated hydraulic work tools, and have an integral hydraulic circuit configured to run these tools. For example, if the work vehicle is an excavator, an arm of the excavator and any tools attached to the excavator arm may be operated using the integral hydraulic circuit.

It is known to provide an ancillary hydraulic circuit on work machines, which is ancillary to the integral hydraulic circuit. The ancillary hydraulic circuit is configured to run ancillary hydraulic power tools, which are normally more independent of the work vehicle, such as hydraulic breakers or concrete saws. These ancillary hydraulic power tools may be powered by the ancillary hydraulic circuit and are therefore tethered to the work vehicle by the ancillary hydraulic circuit but are otherwise usable within a radius of the work vehicle dictated by the length of the ancillary hydraulic circuit.

Increasingly, ancillary power tools may be electrically rather than hydraulically powered.

### SUMMARY OF THE DISCLOSURE

Against this background, there is provided a modular battery for an electric work vehicle, the modular battery comprising a first battery pack configured to power the electric work vehicle and a second battery pack configured to power the electric work vehicle and to power an auxiliary electric power tool. The second battery pack is configured to be removable from the modular battery and the second battery pack comprises a power converter.

In this way, it is possible to use a modular battery to power an electric work vehicle in one configuration and, in another configuration, to power an auxiliary electric power tool. The first and second battery packs may be used to power the electric work vehicle together or individually. The second battery pack may be removed, physically or electrically, from the modular battery and may be used to power an auxiliary electric power tool.

### BRIEF DESCRIPTION OF THE DRAWINGS

A specific embodiment of the disclosure will now be described, by way of example only, with reference to the accompanying drawings in which:

FIG. 1 shows a schematic diagram of an example of a modular battery according to an embodiment of this disclosure. The example of the modular battery comprises eight battery packs.

FIG. 2 shows a schematic diagram of the modular battery pack of FIG. 1, with one battery pack removed and connected to an auxiliary electric power tool in accordance with an embodiment of this disclosure.

FIG. 3 shows a schematic diagram of a modular battery comprising two battery packs in accordance with an embodiment of this disclosure, with an electric work vehicle.

### DETAILED DESCRIPTION

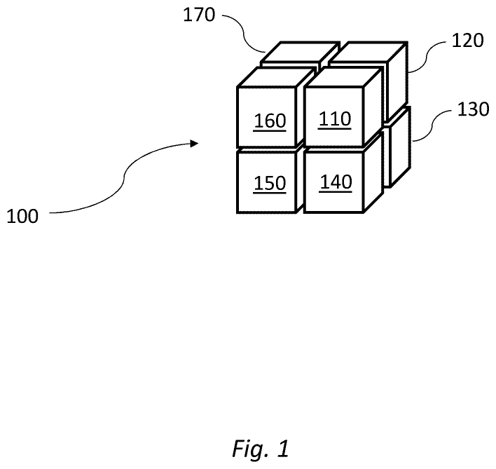

With reference to FIG. 1, a module battery 100 is configured to power an electric work vehicle. The modular battery 100 comprises two or more battery packs. The modular battery 100 shown in FIG. 1 comprises eight battery packs (of which seven are visible, 110, 120, 130, 140, 150, 160 and 170), however this is an example and the modular battery 100 may comprise any number of battery packs above one.

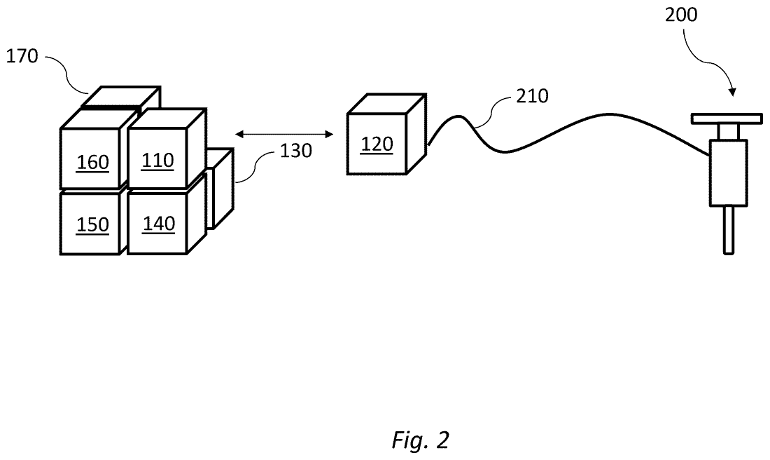

The modular battery pack 100 comprises first battery pack 110 configured to power the electric work vehicle. The modular battery pack 100 further comprises a second battery pack 120 configured to be removable from the modular battery 100. FIG. 1 shows the second battery pack 120 mounted in the modular battery 100, and FIG. 2 shows the second battery pack 120 removed from the modular battery 100. The second battery pack 120 is configured to power the electric work vehicle and to power an auxiliary electric power tool 200. The second battery pack 120 comprises a power converter.

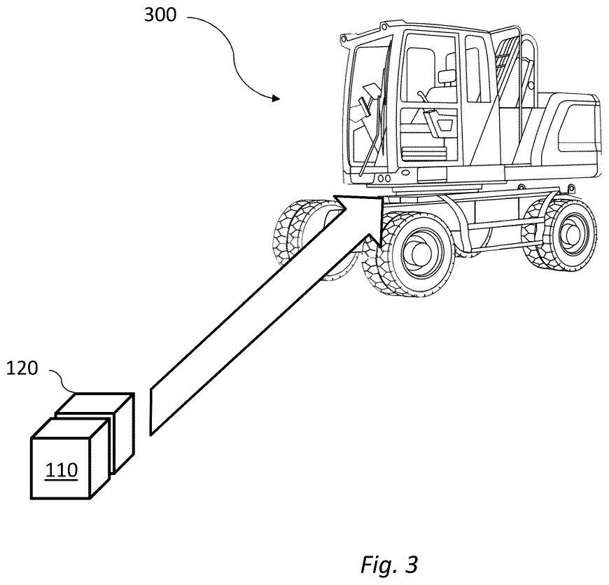

FIG. 3 shows a schematic diagram illustrating that the modular battery may be mounted on an electric work vehicle 300. The modular battery shown in FIG. 3 comprises a first battery pack 110 and a second battery pack 120. The specific electric work vehicle 300 in FIG. 3 is shown as an example. The electric work vehicle 300 may comprise any other type of electric work vehicle.

In an embodiment, the power converter comprises a DC to AC inverter.

The second battery pack 120 may be configured to be in a first state and a second state. In the first state the second battery pack 120 may be mounted to the electric work vehicle. In the first state the second battery pack 120 may be configured to power the electric work vehicle. In the second state the second battery pack 120 may be dismounted from the electric work vehicle (or dismounted from the modular battery) and may be configured to power the auxiliary electric power tool 200.

In another embodiment, the second battery pack 120 may be configured to be in a first state and a third state. In the first state the second battery pack 120 may be mounted to the electric work vehicle (or mounted to the modular battery) and may be configured to power the electric work vehicle. In the third state the second battery pack 120 may be physically mounted to the electric work vehicle (or mounted to the modular battery) but may be electrically removed or disconnected, such that the second battery 120 is configured to power the auxiliary electric power tool. In other words the second battery pack 120 may remain physically mounted to the modular battery 100, but may be electrically removable.

In an embodiment, the auxiliary electric power tool 200 may be separate to the electric work vehicle. The second battery pack 120 may be configured to be connected to the auxiliary electric power tool 200 by a cable (shown as 210 in FIG. 2). The second battery pack 120 may be configured to be connected to the auxiliary electric power tool 200 by a cable in the second state (wherein the second battery pack 120 is dismounted from the electric work vehicle), or the second battery pack 120 may be configured to be connected to the auxiliary electric power tool 200 by a cable in the third state (wherein the second battery pack 120 is mounted to the modular battery but is electrically removed from the modular battery). The second battery pack 120 may be configured to be mounted directly to the auxiliary electric power tool 200 in the second state. By contrast with an auxiliary hydraulic fluid circuit, the length of which is necessarily limited by the limitations of the hydraulic system, a power cable may be provided having significantly greater length.

In an embodiment, the electric work vehicle may comprise the auxiliary electric power tool. As described above, the second battery pack 120 may be configured to be electrically removable wherein in a first state the second battery pack 120 is configured to power the electric work vehicle and in a third state the second battery pack 120 is configured to power the auxiliary electric power tool.

In an embodiment, the first battery pack 110 may be configured to connect to the second battery pack 120 such that charge can be exchanged between the first battery pack 110 and the second battery pack 120.

In an embodiment, at least one of the first battery pack 110 and the second battery pack 120 is further configured to be connected to a battery of a second electric work vehicle and to exchange charge with the battery of the second electric work vehicle while the first and second electric work vehicles are stationary. The first and second electric work vehicles may be prevented from moving or from operating work tools while charge is being exchanged between the first electric work vehicle and the second electric work vehicle. The battery of the first electric work vehicle may therefore be able to charge the battery of the second electric work vehicle, and vice versa. The charging may be DC or AC.

In an embodiment, at least one of the first battery pack 110 and the second battery pack 120 may be configured to be physically removed from the modular battery 100 and mounted on a modular battery of a second electric work vehicle.

The first or second battery packs 110, 120 may be configured to be connected to the battery of the second electric work vehicle via DC ports.

The first battery pack may be further configured to power the auxiliary electric power tool and to be removable from the modular battery. The first battery pack may comprise a power converter.

The modular battery may further comprise one or more additional battery packs, so that the modular battery comprises more than two battery packs (see FIG. 1 for an example). Any of the additional battery packs may be similar to the first battery pack or to the second battery pack. The one or more additional battery packs may be configured to power the electric work vehicle. One or more of the additional battery packs may be configured to be removable from the electric work vehicle. One or more of the additional battery packs may be further configured to power an auxiliary electric power tool and may comprise a power converter.

The first battery pack may be configured to power the electric work vehicle individually or in combination with the second battery pack. The wherein the second battery pack may configured to power the electric work vehicle individually or in combination with the first battery pack. For example, in an event that the second battery pack is being used to power the auxiliary electric power tool, the first battery pack may simultaneously be used to power the electric work vehicle.

1. A modular battery for an electric work vehicle, the modular battery comprising:
a first battery pack configured to power the electric work vehicle; and
a second battery pack configured to power the electric work vehicle and to power an auxiliary electric power tool;
wherein the second battery pack is configured to be removable from the modular battery and wherein the second battery pack comprises a power converter.

2. The modular battery of claim 1 wherein the power converter comprises a DC to AC inverter.

3. The modular battery of claim 1 wherein the second battery pack comprises a first state and a second state, wherein:
in the first state the second battery pack is mounted to the electric work vehicle; and
in the second state the second battery pack is dismounted from the electric work vehicle and is configured to power the auxiliary electric power tool.

4. The modular battery of claim 1 wherein the auxiliary electric power tool is separate to the electric work vehicle.

5. The modular battery of claim 1 wherein the second battery pack comprises a first state and a third state, wherein:
in the first state the second battery pack is mounted to the electric work vehicle; and
in the third state the second battery pack is mounted to the electric work vehicle and is electrically removed from the modular battery such that the second battery pack is configured to power the auxiliary electric power tool and is configured not to power the electric work vehicle.

6. The modular battery of claim 5 wherein the electric work vehicle comprises the auxiliary electric power tool.

7. The modular battery of claim 5 wherein the auxiliary electric power tool is not mounted on the electric work vehicle and wherein the auxiliary electric power tool is either:
not connected to the electric work vehicle; or
connected to the electric work vehicle via the second battery pack.

8. The modular battery of claim 1 wherein the first battery pack is configured to connect to the second battery pack such that charge can be exchanged between the first battery pack and the second battery pack.

9. The modular battery of claim 1 wherein at least one of the first battery pack and the second battery pack is further configured to be connected to a battery of a second electric work vehicle and to exchange charge with the battery of the second electric work vehicle.

10. The modular battery of claim 1 wherein at least one of the first battery pack and the second battery pack is further configured to be removable from the electric work vehicle.

11. The modular battery of claim 9 wherein the first or second battery pack is configured to be connected to the battery of the second electric work vehicle via DC ports.

12. The modular battery of claim 1 wherein the first battery pack is further configured to power the auxiliary electric power tool and to be removable from the modular battery, and wherein the first battery pack comprises a power converter.

13. The modular battery of claim 1 further comprising one or more additional battery packs configured to power the electric work vehicle and configured to be removable from the electric work vehicle.

14. The modular battery of claim 13 wherein at least one of the one or more additional battery packs is further configured to power an auxiliary electric power tool and comprises a power converter.

15. The modular battery of claim 1 wherein the first battery pack is configured to power the electric work vehicle individually or in combination with the second battery pack and wherein the second battery pack is configured to power the electric work vehicle individually or in combination with the first battery pack.

16. A method for using a modular battery pack to power an electric work vehicle and an electric power tool, comprising:
using a first battery pack of the modular battery to power the electric work vehicle; and
using a second battery pack of the modular battery to power the electric power tool, wherein:
the second battery pack is removable from the modular battery; and
a direct current output of the second battery pack is converted to an alternating current for powering the electric power tool.

17. The method for using the modular battery pack to power the electric work vehicle and the electric power tool of claim 16, further comprising:
removing the second battery pack from the electric work vehicle and using the second battery pack to power the electric power tool.

18. The method for using the modular battery pack to power the electric work vehicle and the electric power tool of claim 16, wherein the second battery pack is used to power the electric work vehicle.
